(19) United States
(12) Patent Application Publication
(10) Pub. No.: US 2008/0151259 A1
(43) Pub. Date: Jun. 26, 2008

(54) SYNCHRONIZED WAFER MAPPING

(76) Inventor: Woo Sik Yoo, Palo Alto, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/614,837

(22) Filed: Dec. 21, 2006

(51) Int. Cl. G01B 9/02; G01N 21/55

(52) U.S. Cl. 356/521; 356/445

(57) ABSTRACT

A system and method for mapping a wafer includes scanning the wafer with a laser beam using a continuous spiraling pattern on the wafer surface, where the spiraling can be inward or outward. A microprocessor analyzes characteristics of the reflected, diffracted, and/or scattered beams and synchronizes each beam with a location on the wafer to generate a map of the wafer.

### BACKGROUND OF THE INVENTION

1. Field of the Invention

This invention generally relates to wafer mapping.

2. Related Art

Wafer mapping is typically used to measure material properties of a wafer during various stages of semiconductor processing, such as for the manufacture of integrated circuits. Integrated circuits are typically manufactured on thin silicon substrates, commonly referred to as wafers. The wafer is divided up onto smaller rectangular sections for each device, typically known as the die or device, where the wafer can include multiple oxide (insulating) layers and metal (conducting) layers. Each layer may have defects, such as metallization defects (e.g., scratches, voids, corrosion, bridging), diffusion defects, passivation layer defects, scribing defects, chips and cracks from sawing, probe or bond area defects (e.g., missing probe marks, discoloration, missing metal and probe bridging), and diffusion faults. The originally purchased blank wafer may also have defects prior to any manufacturing. Such defects, incurred during the manufacturing process or even prior, can reduce process yield and increase manufacturing costs.

As a result, the wafer is mapped at various stages of manufacture to determine if defects are present. This enables a faulty wafer to be discarded and prevents unneeded further processing. Alternatively, the defect can be identified and corrected if possible. Thus, one advantage of inspecting semiconductors throughout the manufacturing process is that bad wafers may be removed at the various steps rather than processed to completion only to find out a defect exists either by end inspection or by failure during use. Another purpose of inspection is to monitor the process quality at each process step and/or to evaluate the impact of each process step on the process quality by measuring/inspecting the wafer condition before and after a process step. By comparing the maps before and after process step(s), the impact or influence of an individual process step on the wafer can be easily identified or diagnosed. The process condition can be optimized using the information obtained from the wafer mapping. Variations or unexpected process shifts of process conditions can be detected based on the mapping results.

One method to assist in failure analysis is mapping important variables, such as yield, according to the position at which the variable is read on the substrate. Wafer mapping can produce a graphical representation depicting the yield or other variable read from the devices on the substrate, according to their position on the substrate. Various methodologies exist for detecting and analyzing defects on wafer surfaces. One method is to use a scanning laser microscope to measure amount, location, and size of particles on the wafer surface. Depending on the coordinate system, the data can be transformed to convert the positional data to the appropriate coordinates.

For example, in an r-θ coordinate system, the wafer or laser is moved to specific points on the wafer, where a measurement is taken. FIG. 1A shows a wafer 10, which is mapped in an r-θ coordinate system. The measuring beam or wafer is moved to a point with a specific r and θ value, where a measurement is recorded. The beam or wafer is then moved to another point with specific r and θ value for the next measurement. This continues until the wafer is sufficiently mapped. In this type of wafer mapping, the measurement is at discrete points and times. Because of the start-stop nature, the total wafer mapping can be slow and cumbersome.

Another conventional scanning method is shown in FIG. 1B, which uses an X-Y coordinate system. Here, wafer 10 is moved in a raster scan under a stationary focused laser beam. The wafer may alternatively be held stationary, while the laser beam moves in a raster pattern to scan. Either way, the scanning and measurements are mostly continuous, e.g., during the horizontal scanning and vertical scanning. However, the wafer and/or the laser beam still needs to stop and start, such as at the start and end of a horizontal scan (along the X-direction) or at the start and end of a vertical scan (along the Y-direction), which reduces the overall measurement time. Furthermore, with a raster scan, the number of available measurements or data points may be limited, resulting in a possibly inaccurate mapping or missed defects.

Therefore, there is a need for a wafer mapping system that overcomes the disadvantages of conventional methods discussed above.

### SUMMARY

According to one aspect of the present invention, a wafer is mapped using a continuous inwardly spiraling pattern or a continuous outwardly spiraling pattern. In one embodiment, the wafer is rotated and moved laterally, while a fixed laser beam impinges on the wafer surface. In another embodiment, the wafer is rotated, while the laser beam moves laterally to scan a spiral pattern on the wafer. This type of wafer mapping provides very fast data acquisition, high productivity, large numbers of data points, and high resolution and accuracy, due in part to the continuous nature and pattern of the scanning.

In one embodiment, a computer or microprocessor calculates the rotational speed of the wafer during the mapping process. If the wafer also moves laterally, the lateral speed is also determined. The wafer is then rotated (and possibly moved), while a laser beam impinges on the wafer surface. Initially the laser beam is directed to a center portion of the wafer (for a spiraling-out scan) or to an outer portion of the wafer (for a spiraling-in scan). As the wafer rotates (and either the wafer or the laser moves laterally), the beam reflected from the wafer surface is received by a detector or camera, which generates a representative signal. The signal, corresponding to the reflected beam and/or a diffracted or scattered beam by defects or impurities on the wafer, is then input to the computer. The computer, using the reflected, diffracted and/or scattered signal and wafer stage coordinate information (e.g., actual rotation speed, translation, and location information corresponding to the reflected, diffracted and/or scattered beam), correlates and synchronizes the coordinate information on the wafer with the image from the detector or camera. Conventional processing and data analysis continues, such as comparing the image signal with stored values, compiling an image map or matrix, and/or displaying the mapped image.

By using a continuous spiral scan, the wafer can be quickly and accurately mapped due to the large number of data points acquired in a relatively short time.

### BRIEF DESCRIPTION OF THE FIGURES

FIG. 1A shows a conventional discrete wafer scanning pattern;

FIG. 1B shows a conventional raster wafer scanning pattern;

FIGS. 2A and 2B show spiral wafer scanning patterns according to embodiments of the present invention; and

FIG. 3 shows a system for wafer mapping according to one embodiment of the present invention.

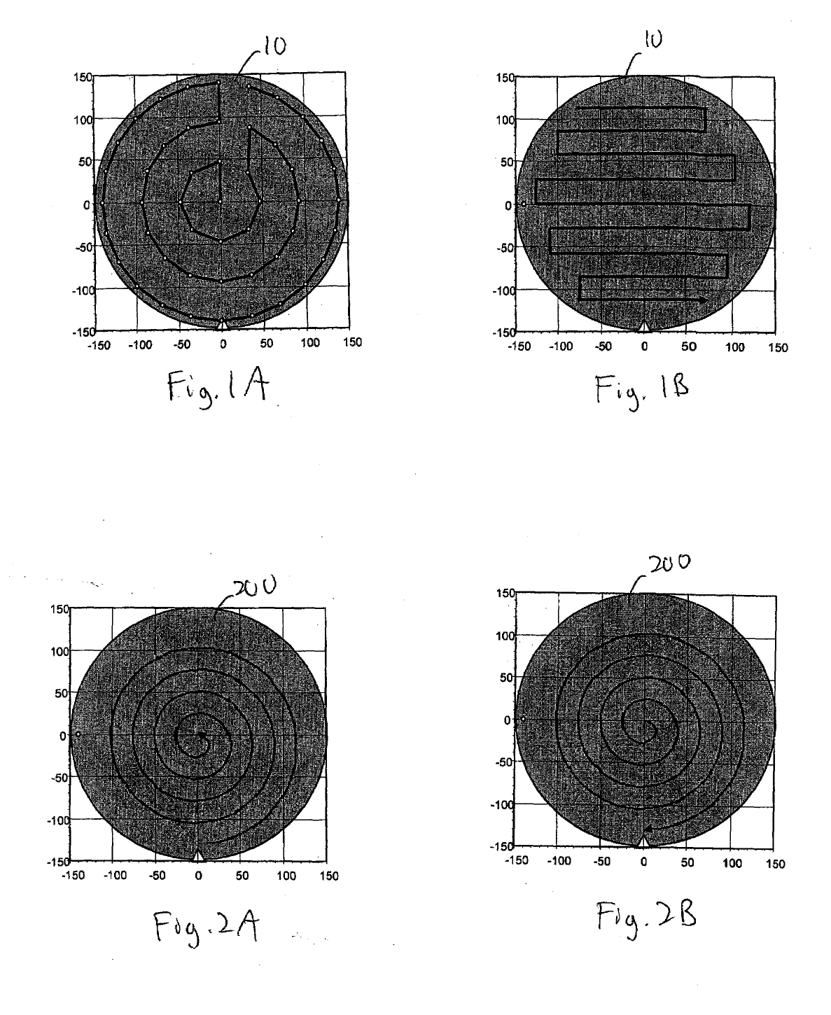

Embodiments of the present invention and their advantages are best understood by referring to the detailed description that follows. It should be appreciated that like reference numerals are used to identify like elements illustrated in one or more of the figures.

### DETAILED DESCRIPTION

According to one aspect of the present invention, a wafer is mapped utilizing a continuous spiraling scanning pattern, where the scanning can spiral in from an outer portion of the wafer or spiral out from a center portion of the wafer. The reflected, diffracted and/or scattered beam (i.e. signal) is synchronized with the beam coordinates so that a fast and accurate mapping of the wafer is possible. Reflected, as used herein, can be an essentially unaltered reflected beam, such as from a mirror, a diffracted beam, a scattered beam, or any type of beam that changes characteristics upon contact with the wafer surface.

FIGS. 2A and 2B show two types of spiral scanning according to embodiments of the invention. In FIG. 2A, the scanning starts at an outer portion of a wafer 200 and spirals inward until the scanning is stopped at the center of wafer 200. FIG. 2B shows another embodiment in which the scanning starts at a center of wafer 200 and spirals outward until it reaches a point on the outer portion of the wafer. Because of the nature of the spirals, the scanning is continuous, which enables fast acquisition of data and rapid mapping of the wafer. Furthermore, because the shape of the spiral is similar to that of the wafer, a more accurate and complete mapping is possible.

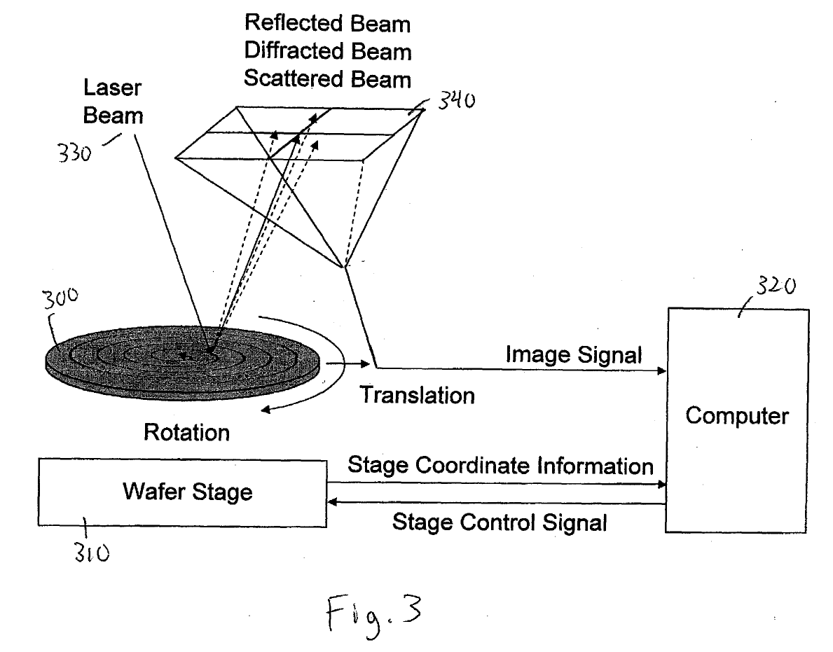

FIG. 3 shows one embodiment of a system for synchronous mapping of a wafer using a spiraling scanning pattern. A wafer 300 to be mapped is mounted on a rotatable mounting device (not shown), which secures the wafer from the edge and/or backside. The rotatable mounting device can be coupled to or a part of a wafer stage 310, which controls the movement of the wafer. In this embodiment, wafer 300 can be simultaneously rotated and moved laterally. Wafer stage 310, which can include mechanical parts for effecting the movement of the wafer as well as a microprocessor or the like for controlling the movement and other necessary functions, receives control signals from a computer or microprocessor 320. Microprocessor 320 can be part of or embedded within other components, such as a user interface, e.g., keyboard, an output device, e.g., a printer, and a visual display, e.g., a screen or GUI. Microprocessor 320, based on user or automated inputs, such as, but not limited to or mandatory, the size of the wafer, the resolution of the mapping, the stage of manufacturing, and the type of surface layer being mapped, sends the proper control signals to wafer stage 310. The control signals control the speed of rotation and translation of wafer 300 during the mapping process. In one embodiment, the wafer is rotated between one and approximately 1000 rpm. As wafer size increases, the scanning speed toward the wafer edge gets faster. Thus, to maintain a constant rpm or a constant scanning speed, the rotational speed can be slowed as the scanning moves toward the wafer edge. The scanning speed determines the spatial resolution of measurement and can be adjusted based on the spatial resolution requirement and productivity of the measurement.

A laser beam 330 or other suitable scanning light source is directed to the surface of wafer 300. Laser bean 330, in this embodiment, is fixed, i.e., does not move during the mapping process. Laser beam 330 is in communication with microprocessor 320 so that the laser beam can be adjusted for a desired wavelength and power. For example, the wavelength should be selected so that the laser beam reflects off the surface of wafer 300 and is not transparent to the wafer material. The light source or laser beam can be in the UV to IR range, e.g., from about 180 nm to about 2.0 μm. As the wafer rotates and moves laterally, the fixed laser beam scans in a spiral pattern on the wafer surface. The initial scanning or mapping can occur on an outer portion of wafer 300 or on a center portion of wafer 300. As the laser beam impinges on the wafer surface, the beam is reflected onto a detector 340. Detector 340 may be a screen or other receiving beam receiving device. Detector 340 may also be a stand-alone element or as part of a system including an image capture device, such as a CCD camera. A photodiode, linear photodiode array, position sensitive solar cell or photomultiplier tube (PMT) may also be suitable.

The reflected beam received by detector 340 may be scattered or diffracted if it impinges on an impurity or defect on the wafer surface. The characteristics of the defect, such as size, type (e.g., inclusion or protrusion), warpage, and/or deformation of bare surface or patterned surface can affect the scattering and/or diffraction angle of the reflected/diffracted/scattered beam, the power of the reflected/diffracted/scattered beam, and possibly the dispersion of the reflected beam. Thus, based on the properties of the reflected beam, the existence of a defect (or lack of defect), type of defect, warpage, and/or deformation can be determined. This determination can be made by microprocessor 320, which receives the signal from detector 340. Microprocessor 320 also receives coordinate information signals from wafer stage 310, which microprocessor 320 uses to synchronize the reflected/diffracted/scattered beam signal with a specific position on wafer 300. Synchronization can be accomplished using standard and known techniques, such as using a synchronization signal during the scanning. The coordinates can be in the r-θ coordinate system or any other suitable coordinate system.

At each scanned location on the wafer, the characteristics of a defect, particle, warpage, or deformation, if one exists, can be determined by microprocessor 320, such as by comparing the characteristics of the scanning beam with the characteristics of the reflected beam. Characteristics may include angle, power, distribution, and dispersion. Processing details of such characteristics for wafer mapping are conventional and known, and thus, no additional description is provided.

Based on the characteristics of the reflected/diffracted/scattered beams and the coordinate information of the illuminated or mapped position on the wafer, microprocessor 320 correlates, synchronizes, and analyzes the data. By compiling a large number of mapped points on the wafer, a map of the wafer can be generated. The scanning beam can be continuous or pulsed. If the beam is continuous, a separate synchronization is needed, similar to a clock signal. If the beam is pulsed, the additional synchronization signal is no longer required because the pulsed beam can be used as a synchronization signal. If it is continuous, we need to supply additional synchronization signal similar to clock signal. The scanning rates and/or number of mapped points are dependent on the spatial resolution requirement for the mapping. The map can be displayed or otherwise presented to the user, such as an image on a screen or a print-out. The wafer map can also be used to identify and correct defects if possible, either manually or automatically. If the defects are substantial, the wafer can be discarded so that unnecessary further processing is not performed. Note that the mapped surface of the wafer can be patterned or unpatterned, at any stage of the wafer processing. Additional details about wafer mapping, which may be used with the present invention, are included in commonly-owned U.S. patent application Ser. No. 11/291,246, filed Nov. 30, 2005, entitled “Optical Sample Characterization System”; Ser. No. 11/268,148, Filed Nov. 7, 2005, entitled “Spectroscopy System”; Ser. No. 11/505,661, filed Aug. 16, 2006, entitled “Spectroscopy System”; and Ser. No. 11/539,426, filed Oct. 6, 2006, entitled “Raman And Photoluminescence Spectroscopy”, all of which are incorporated by reference in their entirety.

Having thus described embodiments of the present invention, persons skilled in the art will recognize that changes may be made in form and detail without departing from the spirit and scope of the invention. For example, in the above description, the laser beam or scanning light source is fixed, while the wafer is both rotated and moved laterally. However, the invention may also be practiced using other methods and systems, such as the wafer only rotating, while the laser moves laterally across the radius of the wafer to form the spiral pattern. Thus the invention is limited only by the following claims.

What is claimed is:

1. A method for mapping a wafer, comprising:
scanning the surface of the wafer with an impinging beam, wherein the scanning forms a continuous spiraling pattern from a first area of the wafer to a second area of the wafer; and
generating a map of the wafer based on beams reflected, diffracted, and/or scattered from the surface of the wafer.

2. The method of claim 1, wherein the first area is in a center portion of the wafer and the second area is in an outer portion of the wafer.

3. The method of claim 1, wherein the first area is in an outer portion of the wafer and the second area is in a center portion of the wafer.

4. The method of claim 1, further comprising rotating the wafer during the scanning.

5. The method of claim 4, further comprising moving the wafer laterally during the scanning.

6. The method of claim 4, further comprising moving the impinging beam laterally during the scanning.

7. The method of claim 1, further comprising synchronizing the reflected, diffracted, and/or scattered beams with corresponding location coordinates on the surface of the wafer.

8. The method of claim 1, wherein the generating comprises determining characteristics of the reflected, diffracted, and/or scattered beams.

9. The method of claim 8, wherein the characteristics comprise scattering angle, power, dispersion and distribution.

10. The method of claim 1, wherein the impinging beam is a laser beam.

11. The method of claim 1, wherein the impinging beam comprises a parallel beam or a focused beam.

12. The method of claim 1, wherein the impinging beam has a wavelength between approximately 180 nm and 2 μm.

13. The method of claim 1, wherein the surface comprises a patterned surface or an unpatterned surface.

14. A system for wafer mapping, comprising:
a rotatable wafer;
a scanning light source configured to direct a beam on the surface of the wafer;
a detector for receiving reflected beams from the surface of the wafer and generating corresponding signals therefrom; and
a microprocessor configured to receive the signals and location information on the wafer corresponding to the signals and generate a map of the wafer, wherein the scanning light source forms a continuous spiraling pattern from a first area of the wafer to a second area of the wafer.

15. The system of claim 14, wherein the detector comprises a screen.

16. The system of claim 14, wherein the detector comprises a camera, CCD, photodiode array, and photo voltaic devices.

17. The system of claim 14, wherein the light source is a laser.

18. The system of claim 14, wherein the light source comprises focused, spread, and/or collimated light beams.

19. The system of claim 14, wherein the light source emits light having wavelengths between approximately 180 nm and 2 μm.

20. The system of claim 17, wherein the light source emits light comprising a coherent beam or a plurality of parallel beams.

21. The system of claim 14, wherein the light source is fixed and the wafer is laterally movable.

22. The system of claim 14, wherein the light source is laterally movable along a radius of the wafer.

23. The system of claim 14, further comprising a wafer stage configured to rotate the wafer and communicate wafer movement information to the microprocessor.

24. The system of claim 23, wherein the wafer movement information comprises wafer rotation and translation speed.

25. The system of claim 14, wherein the location information comprises radius and angle values.

26. The system of claim 14, wherein the signals corresponding to the reflected, diffracted, and/or scattered beams comprise information about power, scattering angle, distribution, and/or dispersion of the reflected, diffracted, and/or scattered beams.
